(19) United States
(12) Patent Application Publication
(10) Pub. No.: US 2025/0381428 A1
(43) Pub. Date: Dec. 18, 2025

(54) Systems and Methods for the Optimal Coordination of Manned and Unmanned Aircraft for Wildfire Surveillance and Suppression

(71) Applicant: U.S. Army DEVCOM, Army Research Laboratory, Adelphi, MD (US)

(72) Inventor: Mahdi Al-Husseini, Kapolei, HI (US)

(73) Assignee: U.S. DEVCOM Army Research Laboratory, Adelphi, MD (US)

(21) Appl. No.: 18/776,310

(22) Filed: Jul. 18, 2024

Related U.S. Application Data
(60) Provisional application No. 63/659,941, filed on Jun. 14, 2024.

(51) Int. Cl. A62C 3/02; G06V 20/17; G06V 20/52

(52) U.S. Cl. CPC A62C 3/0271; A62C 3/0228; G06V 20/17; G06V 20/52

(57) ABSTRACT

A wildfire mitigation manager is described. The wildfire mitigation manager may manage agents during a wildfire in order to achieve a specified goal, such as minimization of damages. Such agents may include surveillance agents and/or suppression agents. The agents may be associated with manned and/or unmanned aircraft. The coordination of unmanned aircraft in proximity to and in conjunction with manned aircraft may result in enhanced wildfire surveillance and suppression performance. Unmanned aircraft conducting surveillance may be selectively guided in order to optimize locations for capturing wildfire information. Manned aircraft may likewise be guided to locations optimized for wildfire suppression and suggestions as to the ideal method of execution (e.g., when using water buckets, spot drops versus line drops) may be provided.

### CROSS-REFERENCE TO RELATED APPLICATIONS

This application claims benefit to U.S. Provisional Patent Application Ser. No. 63/659,941 and filed on Jun. 14, 2024 which is hereby incorporated by reference herein.

### GOVERNMENT INTEREST

The invention described herein may be manufactured, used and licensed by or for the U.S. Government.

### BACKGROUND OF THE INVENTION

Each year since 2000, an average of over seventy thousand wildfires have burned an average of seven million acres, resulting in tens of billions of dollars in damage and thousands of lives lost. In 2020 alone, more than seventeen thousand structures were destroyed, and more than three-thousand-five-hundred people were killed, because of wildfires.

Existing firefighting solutions have failed to utilize low-level integration of unmanned aerial systems (UAS) with existing manned aircraft. Although UAS holds tremendous promise, the on-ground reality remains dominated by manned aircraft conducting both surveillance and suppression efforts—in the military and civilian sector. For example, the California Department of Forestry and Fire Protection (CALFIRE), the premier firefighting aviation program in the world with more firefighting aircraft than any other firefighting department, continues to rely almost entirely on manned aircraft for its surveillance and suppression efforts, with the only notable exception being the regular involvement of California National Guard MQ-9 General Atomic Predator drones for high-altitude (e.g., fifty-thousand ft) mapping.

Therefore, there exists a need to integrate low-altitude UAS into existing manned fleets, while paying special attention to existing tactics, techniques, and procedures (TTPs), airspace models, and good aviation practices, provides immediately beneficial and realistic policies that may greatly support wildfire surveillance and suppression activities.

### BRIEF SUMMARY OF THE INVENTION

Some embodiments of the invention provide ways to manage wildfire surveillance and suppression. Some embodiments may coordinate one or more unmanned aircraft working in conjunction with, and in proximity to, one or more manned aircraft to conduct optimized wildfire surveillance and suppression activities, using a combination of networked systems, Markov decision processes, and reinforcement learning techniques.

Manned-unmanned teaming (MUM-T) is the process by which unmanned aircraft systems (UAS) intelligently collaborate with aviator manned aircraft to optimize mission execution in areas to include firefighting, search and rescue operations, medical evacuation, and gunnery. MUM-T has been demonstrated to be a significant resource effectiveness multiplier. Unmanned aircraft operating in tandem with manned aircraft frees aviators to focus on mission-essential tasks, while allowing critical secondary tasks to be automated.

Effective and safe MUM-T application requires the careful consideration of mission requirements, collision avoidance constraints and controls, and individual agent capabilities. Though the origins of MUM-T reach back decades, there remains a notable lack of formalized doctrine, and a lack of tactics, techniques, and procedures (TTPs) for responsible use. This absence, combined with the existing focus on attack operations rather than firefighting and humanitarian efforts, suggests a notable capability gap that may be well-supported by intelligent systems research. The MUM-T problem of unmanned aircraft control quickly becomes intractable, especially when tailored to even the simplest of wildfire propagation models, with a massive state space requiring several simplifying assumptions or customized algorithms. Further, several sources of uncertainty persist. Outcome uncertainty, where the consequences of taken actions are uncertain, exists when suppression activities are undertaken. State uncertainty, where the state of the environment (e.g., a wildfire environment) is uncertain, is prevalent as aircraft must map the constantly changing fire as the initial response team. Finally, interaction uncertainty is exceedingly common, as the unmanned systems, however controlled, must adjust their actions based on the state of a manned aircraft which is uncontrolled. Indeed, a noted complication of MUM-T policies and procedures is not the unmanned aircraft, but the requisite response to the manned aircraft which, while well-intentioned and generally procedurally trained, remains human.

The formulation of a partially observable Markov decision process (POMDP) reflecting a realistic wildfire MUM-T model defined in part by established wildfire TTPs, and the use of reinforcement learning to map states to actions that maximize expected reward for both surveillance and suppression, is performed by some embodiments. A system of some embodiments may include one or more unmanned aircraft with surveillance capabilities, and one or more manned aircraft with suppression capabilities. Unmanned aircraft may provide wildfire observations, and information such as aircraft location and altitude, to a wildfire mitigation manager of some embodiments, which may then generate or update a wildfire belief map. The belief map, along with the location and altitude of each unmanned aircraft, may be evaluated by the wildfire mitigation manager to determine locations that each unmanned aircraft will travel to for the next surveillance iteration, as well as upcoming suppression guidance to the aircrew aboard the manned aircraft. The wildfire mitigation manager may optimize for one or more potentially competing objectives, which may include accuracy of the wildfire belief map, destruction minimization, and/or extent of fire-spread.

### BRIEF DESCRIPTION OF DRAWINGS

The novel features of the disclosure are set forth in the appended claims. However, for purposes of explanation, several embodiments are illustrated in the following drawings.

FIG. 1 illustrates an example overview of one or more embodiments described herein, in which agents are deployed in response to a wildfire event;

FIG. 2 illustrates an example overview of one or more embodiments described herein, in which various attributes of a wildfire environment relevant to mitigation efforts are compiled;

FIG. 3 illustrates a framework diagram of a hierarchical framework of one or more embodiments, where surveillance and suppression planners operate in a hierarchical manner;

FIG. 4 illustrates a schematic block diagram of an operating environment of one or more embodiments described herein;

FIG. 5 illustrates a schematic block diagram of an unmanned aircraft system (UAS) of one or more embodiments described herein;

FIG. 6 illustrates a schematic block diagram of manned aircraft of one or more embodiments described herein;

FIG. 7 illustrates an example graphical user interface (GUI) of one or more embodiments described herein, where information related to a wildfire is provided to aircraft crew;

FIG. 8 illustrates a temporal flow diagram of one or more embodiments, where surveillance and suppression planning may be performed iteratively and asynchronously;

FIG. 9 illustrates a reward model diagram of one or more embodiments, where suppression planners pursue a goal of minimization of global resource destruction;

FIG. 10 illustrates a two-dimensional plot of one or more embodiments, where the accuracy of wildfire predictions is indicated;

FIG. 11 illustrates a flow chart of an exemplary process that mitigates wildfire damage;

FIG. 12 illustrates a flow chart of an exemplary process that generates or updates a belief map;

FIG. 13 illustrates a flow chart of an exemplary process that generates a mitigation plan;

FIG. 14 illustrates a flow chart of an exemplary process that implements a mitigation plan; and

FIG. 15 illustrates a schematic block diagram of one or more exemplary devices used to implement various embodiments.

### DETAILED DESCRIPTION OF THE INVENTION

The following detailed description describes currently contemplated modes of carrying out exemplary embodiments. The description is not to be taken in a limiting sense, but is made merely for the purpose of illustrating the general principles of some embodiments, as the scope of the disclosure is best defined by the appended claims.

Various features are described below that can each be used independently of one another or in combination with other features. Broadly, some embodiments generally provide ways to manage agents, via a wildfire mitigation manager of some embodiments, during a wildfire to minimize damages. Such agents may include surveillance agents and/or suppression agents. The agents may be associated with manned and/or unmanned aircraft. The coordination of unmanned aircraft in proximity to and in conjunction with manned aircraft may result in enhanced wildfire surveillance and suppression performance. Unmanned aircraft conducting surveillance may be selectively guided in order to optimize locations for capturing wildfire information. Manned aircraft may likewise be guided to locations optimized for wildfire suppression and suggestions as to the ideal method of execution (e.g., when using water buckets, spot drops versus line drops) may be provided.

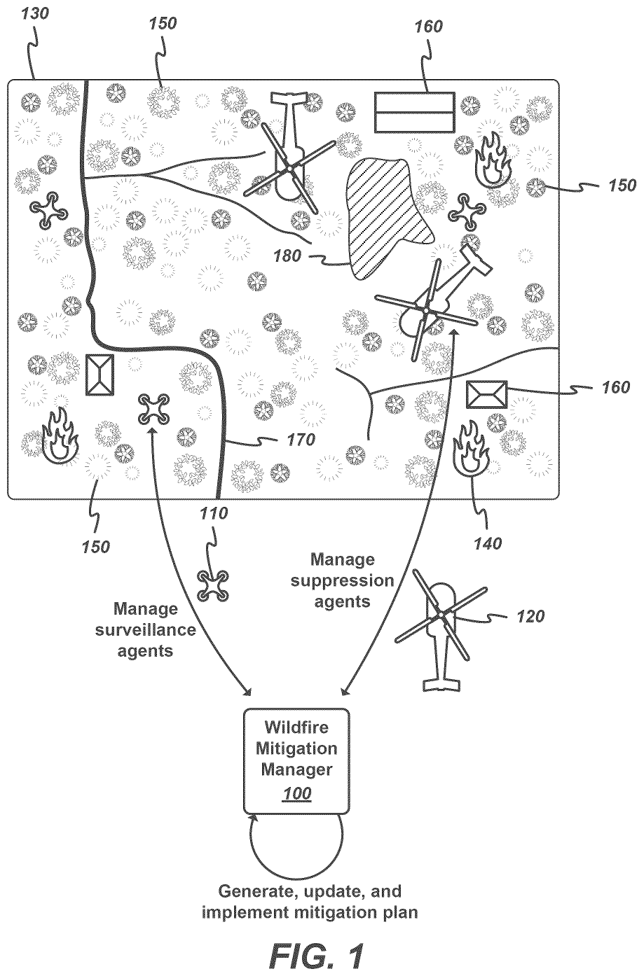

FIG. 1 illustrates an example overview of one or more embodiments described herein, in which agents are deployed in response to a wildfire event. As shown, a wildfire mitigation manager 100 may interact with, and/or at least partly direct the operations of, surveillance agents 110 and suppression agents 120. In this example, a wildfire event is associated with geographic area 130, which may be associated with observed events 140, various types of vegetation and/or other fuel 150, structures and/or other resources 160, roads or other geographic features 170, bodies of water 180, and/or other appropriate elements or features.

Wildfire mitigation manager 100 may be, include, and/or utilize various components, devices, and/or systems, which are capable of executing instructions and/or otherwise processing data. Wildfire mitigation manager 100 may be implemented using a device such as device 1500 described below. Wildfire mitigation manager 100 may at least partly direct the operations of surveillance agents 110, suppression agents 120, and/or other agents. Wildfire mitigation manager 100 may be located aboard one or more of the surveillance agents 110 and/or suppression agents 120, or may be located at a ground station (not shown) and/or some other appropriate resource(s).

Each surveillance agent 110 may be an electromechanical device or system that is able to travel through airspace and capture surveillance data (e.g., image data). In some embodiments, surveillance agents 110 may typically be unmanned aircraft that are able to be at least partially controlled by the wildfire mitigation manager 100. For example, the wildfire mitigation manager 100 may send navigation or guidance commands to the surveillance agents 110 that indicate locations to which the surveillance agents 110 should travel. Such guidance commands may include information such as a target location or position (e.g., a global positioning system (GPS) position and altitude), direction and speed headings, flight path information (e.g., a set of waypoints indicating location and altitude), and/or other relevant information that may be used to direct the position of the surveillance agents 110. Such guidance commands may also indicate, if appropriate, the types of data to capture (e.g., image, temperature, environmental, weather, etc.) and/or attributes thereof (e.g., region of interest for an image as indicated by a radius or other appropriate parameter).

In some embodiments, the wildfire mitigation manager 100 may control all flight operations of an agent such as surveillance agent 110. For instance, the wildfire mitigation manager may receive updates from the surveillance agent 110 regarding position, orientation, environmental conditions, at regular intervals and may send guidance commands in reply at corresponding regular intervals. Thus, the locomotion of the surveillance agent 110, for example, may be directly controlled by the wildfire mitigation manager 100 in some cases.

Each suppression agent 120 may be an electromechanical device or system that is able to travel through airspace and implement suppressive actions, such as dropping water or fire-retardant material. In some embodiments, suppression agents 120 may typically be manned aircraft associated with one or more crew members. Such suppression agents 120 may be able to be at least partially controlled by the wildfire mitigation manager 100 and/or receive instructions or guidance from the wildfire mitigation manager 100.

For example, the wildfire mitigation manager 100 may send navigation or guidance commands to the suppression agents 120 that indicate locations to which the suppression agents 120 should travel. Such guidance commands or instructions may be similar to those described above. Similarly, wildfire mitigation manager 100 may send suppression commands or instructions indicating suppressive actions to be taken. Such suppression commands or instructions may include, for example, a target location (e.g., for a point drop) or path (e.g., for a line drop), type of suppression (e.g., water drop, release flame retardant materials, etc.), volume or quantity of a suppressive action (e.g., specifying the amount of water or quantity of flame-retardant material to drop), and/or other relevant attributes of the suppressive action (e.g., path and speed, start location, end location, etc.). Suppressive actions may include actions such as re-supply (e.g., an empty water tank may be filled by dipping into a body of water 180 such as a lake, an agent may refill flame-retardant material at a base station, etc.).

Each surveillance agent 110, each suppression agent 120, and/or other agents such as ground vehicles may generally include a fuel storage (e.g., a battery, a fuel tank, etc.), some means of locomotion (e.g., one or more propellors or jet engines), directional control (e.g., via rotors, rudders, etc.), altitude control (e.g., via speed control, rotors, rudders, etc.), and/or orientation control (e.g., via a set of accelerometers, gyroscopes, and/or other appropriate elements).

In some embodiments, surveillance agents 110 may also have suppression capabilities (e.g., may be able to implement one or more suppressive actions) and/or suppression agents 120 may also have surveillance capabilities (e.g., may be able to capture image, temperature, and/or environmental data such as wind speed). The division of surveillance and suppression responsibilities to individual and teams of aircraft, while ensuring appropriate collision avoidance considerations are in effect, allows for strategic initial attack operation wildfire techniques.

The response team may include one or more unmanned aircraft and one or more manned aircraft, with any combination of suppression or surveillance responsibilities. Above ground level are the agents 110 and 120, including unmanned and manned aircraft. The unmanned aircraft and unmanned aircraft may be restricted to operation at differing altitude windows to ensure airspace deconfliction. However, reasonably speaking, the aircraft will typically operate around the same altitude due to the imaging and suppression requirements. Thus, as designed into the surveillance reward models, lateral clearance may be provided between the manned and unmanned aircraft.

Geographic area 130 may be a region associated with risk of wildfire events, an area with an active wildfire, and/or other appropriate area to be monitored (e.g., an area associated with a regional government entity). Wildfires may generally be associated with remote areas including forests or other fuel-rich environments. In this two-dimensional representation, elevation of the terrain is not indicated for clarity, but in a typical application, such data would be available to the wildfire mitigation manager 100.

Each observed event 140 or fire cell may be associated with a burning fire having certain attributes (e.g., size, temperature, location, fuel source, etc.). In this example, observed events 140 are indicated as flame icons, but such events may be associated with other sensed conditions than active flames. For instance, a hot area of ground, smoke, flying embers, and/or other activity that may be associated with a wildfire may be identified as observed events 0140. Each observed event 140 may be associated with a position (e.g., using GPS coordinates, elevation, and/or other appropriate information) and/or area (e.g., by defining a perimeter using multiple coordinates, by defining a center point and radius, etc.). In some embodiments, data related to observed events 140 may be analyzed by the wildfire mitigation manager 100 to associate or combine fire instances represented by observed events 140 to identify elements of a larger wildfire, such as a wall, head, perimeter or outer ring, etc.

Observed events 140 may be observed and/or captured by the surveillance agents 110, the suppression agents 120, and/or other agents (e.g., ground-based equipment such as fixed cameras, manned or unmanned vehicles, personnel such as firefighters, etc.). Notifications or messages indicating information related to such observed events 140 may be received by the wildfire mitigation manager 100 from the surveillance agents 110, the suppression agents 120, and/or other agents. In some embodiments, image data captured by the surveillance agents 110, the suppression agents 120, and/or other agents may be received by the wildfire mitigation manager 100 and analyzed to identify observed events 140 and determine attributes thereof (e.g., type, location, size, etc.).

Vegetation or fuel 150 may affect propagation patterns and/or visibility with respect to observed events 140 and/or other events or visible features. In some embodiments, wildfire mitigation manager 100 may determine or estimate an amount of energy stored by the vegetation or fuel 150. Each instance of vegetation or fuel 150 may be associated with a position (e.g., using GPS coordinates, elevation, and/or other appropriate information) and/or area (e.g., by defining a perimeter using multiple coordinates, by defining a center point and radius, etc.). In some embodiments, wildfire mitigation manager 100 may determine an amount of energy stored by the vegetation or fuel 150 based on, for example, size, type, and/or other relevant information.

Structures and/or other resources 160 may include, for example, houses or other residences, industrial or commercial buildings, public structures such as schools or hospitals, and/or types of structures. Although represented as buildings, structures and other resources 160 may include, for example, people, livestock, crops, goods, and/or any other entities that may have a quantifiable value. Of course, structures and/or other resources 160 may also serve as fuel 150, where flammable materials are used. Each structure and/or other resource 160 may be associated with a position (e.g., using GPS coordinates, elevation, and/or other appropriate information) and/or area (e.g., by defining a perimeter using multiple coordinates, by defining a center point and radius, etc.).

Roads and/or other geographic features 170 may include, for example, roadways, paths, physical barriers (e.g., a retaining wall, cliff face, etc.), gates and/or fences, and/or any other features that may be relevant to wildfire mitigation. Firebreaks or similar features may have a similar representation to roads 170 (e.g., lines of varying thickness, color, pattern, etc.). Each road and/or other geographic feature 170 may be associated with a position (e.g., using GPS coordinates, elevation, and/or other appropriate information), area (e.g., by defining a perimeter using multiple coordinates, by defining a center point and radius, etc.), path (e.g., a series of points or a set of vectors), and/or other appropriate information to represent the road and/or other geographic feature 170.

Bodies of water and/or other supplies 180 may include, for example, ponds, lakes, rivers, streams, bays, oceans, etc. Some bodies of water 180 may be used as supplies for suppression efforts (e.g., water may be retrieved from a lake or pond by a suppression agent 120). Some bodies of water 180 may serve as natural firebreaks or area delimiters (e.g., rivers or streams). Each body of water 180 may be associated with a position (e.g., using GPS coordinates, elevation, and/or other appropriate information) and/or area (e.g., by defining a shoreline perimeter using multiple coordinates, by defining a path, etc.).

Vegetation or other fuel 150, structures and/or other resources 160, roads and/or other geographic features 170, bodies of water and/or other supplies 180 may be identified, and attributes thereof may be determined, in various appropriate ways. For instance, image data captured by surveillance agents 110 may be analyzed by the wildfire mitigation manager to identify vegetation or other fuel 150 and determine attributes thereof (e.g., location, size, etc.). In some cases, a single item may be able to be classified across multiple types (e.g., a resource 160 may also be a source of fuel 150). As another example, a river or similar body of water 180 may also be recognized as a firebreak classified as a road and/or other geographic feature 170. In some embodiments, information related to vegetation or other fuel 150, structures and/or other resources 160, roads and/or other geographic features 170, bodies of water and/or other supplies 180 (e.g., position and/or other attributes) may be stored to a map database or similar resource for use by the wildfire mitigation manager 100.

During operation, wildfire mitigation manager 100 may monitor one or more geographic areas 130 (and/or portions thereof). Such monitoring may include, for example, directing one or more surveillance agents 110 to capture image data related to the geographic area 130, for example by sending a target position and request for image capture to a surveillance agent 110. In some embodiments, MCTS, and/or other heuristic search algorithms may be used to efficiently and effectively explore the space associated with the geographic area 130 or other region. In some cases, one or more surveillance agents 110 may autonomously patrol one or more specified regions and capture data at regular intervals and/or based on some specified criteria (e.g., matching a profile associated with an observed event 140, based on analysis by a machine learning model, etc.).

The surveillance agents 110 may capture image data (and/or other appropriate data such as wind speed, temperature, etc.) at the specified position using a camera and/or other appropriate sensors. The captured data may be received by the wildfire mitigation manager 100 and may be analyzed to identify observed events 140.

Observed events 140 may be identified in various appropriate ways. For instance, various event types may be associated with event profiles (e.g., small fire, large fire, smoldering coals, flying embers, etc.) that may include matching criteria and/or threshold information, such as image data, temperature and/or other sensor data, and/or other relevant information. Data associated with observed events 140 may be aggregated or otherwise combined to form a belief map indicating a current state of the wildfire.

Based on the belief map, wildfire mitigation manager 100 may direct various appropriate responses, depending on, for example, belief map attributes (e.g., number and type of observed events 140, proximity to resources 160 or fuel 150, outer ring prediction, etc.), availability of surveillance agents 110 and/or suppression agents 120, and/or other relevant factors. As one example, wildfire mitigation manager 100 may direct the surveillance agent 110 to capture image and/or other data at additional locations for further analysis. As another example, wildfire mitigation manager 100 may direct one or more suppression agents 120 to perform suppressive actions at one or more specified locations. Such response and/or mitigation actions may be identified in various appropriate ways. For example, data associated with the belief map (and/or unaggregated observed events 140) may be analyzed and compared to various response profiles to identify a matching or optimum response. As another example, a machine learning model may indicate an action or response based on analysis of the data associated with the belief map and/or observed events 140.

As suppressive actions and/or other responses are performed, wildfire mitigation manager 100 may continue to direct the one or more surveillance agents 110 to collect image data regarding the geographic area 130 in order to update the belief map. The updated belief map may be used to determine, for example, the current wildfire state and evaluate the effectiveness of such actions. Wildfire mitigation manager 100 may be able to direct or at least partly control, the response to one or more observed events 140 that may be associated with one or more active wildfires. For instance, wildfire mitigation manager 100 may direct or partly control deployment of resources, such as by directing additional surveillance agents 110 and/or suppression agents 120 to deploy and/or to return to a base station or similar resource. As another example, wildfire mitigation manager 100 may direct or partly control agent actions, such as image capture at a specified location, suppressive actions, refueling, resupply of water or fire-retardant materials, etc.

Wildfire mitigation manager 100 may manage the air space and/or otherwise manage flight control associated with a geographic region 130. For example, wildfire mitigation manager 100 may track a current location of each active or available surveillance agent 110 (and/or suppression agent 120) and direct movements of such surveillance agents 110 (and/or suppression agents 120) in order to avoid collisions or interference (e.g., by specifying non-overlapping flight paths, by maintaining a minimum distance between surveillance agents 110 and/or suppression agents 120, etc.). For manned surveillance agents 110 and/or suppression agents 120, the wildfire mitigation manager 100 may provide guidance or instructions to crew member including, for example, suggested flight paths, location of suppressive actions (e.g., as specified by GPS position and altitude), information related to the position (and/or flight path) of other surveillance agents 110 and/or suppression agents 120, etc. to aid crew members in avoiding collisions or other interference.

Wildfire mitigation manager 100 may iteratively update the belief map and/or make predictions as to future states of the belief map based on data received from the surveillance agents 110, suppression agents 120, and/or other agents or entities. For example, predicted belief maps may be generated for future times (e.g., ten minutes, twenty minutes, two hours, etc.) and used to direct, for example, positioning or deployment of the surveillance agents 110, suppression agents 120, and/or other agents or entities.

Wildfire mitigation manager 100 may implement various appropriate goals and/or associated reward structures. For example, wildfire mitigation manager 100 may implement a goal of minimum total destruction of resources 160, where resources may be valued in various appropriate ways (e.g., by assigning a dollar value based on replacement cost, determining an actuarial economic value associated with a human life, etc.). Such goals and/or associated rewards may be used to direct, for example, positioning or deployment of the surveillance agents 110, suppression agents 120, and/or other agents or entities, suppressive actions, surveillance actions, etc.

One of ordinary skill in the art will recognize that FIG. 1 provides a simplified overview and various features may be different in various different embodiments. For example, elements may not be represented to scale. As another example, any number of agents may be available. As another example, some areas may not include certain elements (e.g., a remote forest area may not have any associated structures 160 or roadways 170). As still another example, surveillance agents 110, suppression agents 120, and/or other agents may be able to communicate with each other in addition to the wildfire mitigation manager 100. Various aspects of the overview (and/or elements thereof) will be described in more detail below.

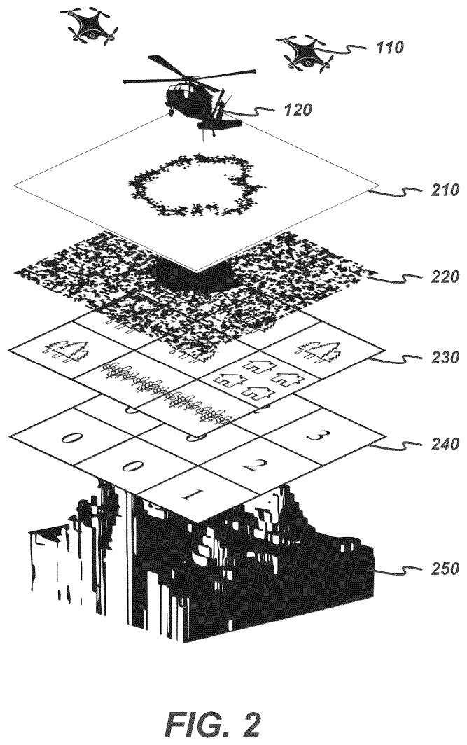

FIG. 2 illustrates an example overview of one or more embodiments described herein, in which various attributes of a wildfire environment relevant to mitigation efforts are compiled. As shown, attributes of the wildfire environment may include information related to surveillance agents 110, suppression agents 120, and/or other available agents, current wildfire state 210, fuel 220, resources 230, environmental conditions 240, geography 250, and/or other relevant information.

Information related to surveillance agents 110 may include, for instance, type (e.g., unmanned aircraft, manned aircraft, ground vehicle, cameras or other sensors, personnel, etc.), location (e.g., GPS coordinates, altitude, direction of travel, speed, etc.), capabilities (e.g., fuel levels, levels of fire mitigation resources such as water or retardant materials, types of sensors, etc.), crew information, and/or other relevant information.

Information related to suppression agents 120 may include, for instance, type (e.g., unmanned aircraft, manned aircraft, ground vehicle, cameras or other sensors, personnel, etc.), location (e.g., GPS coordinates, altitude, direction of travel, speed, etc.), capabilities (e.g., fuel levels, levels of fire mitigation resources such as water or retardant materials, types of sensors, etc.), crew information, and/or other relevant information.

Information related to other agents may include, for instance, type (e.g., fixed location camera or other sensor, stationary mitigation resources such as sprinklers, fire doors, etc.), crew or personnel information, and/or other relevant information.

Information related to the current wildfire state 210 may include, for example, image data (e.g., image data captured by surveillance agents 110, suppression agents 120, and/or other types of agents), temperature data, and/or other relevant information.

Information related to fuel 220 may include, for example, type (e.g., vegetation, structure, fuel tank, etc.), attributes related to location and quantity, attributes related to combustibility, and/or other relevant information.

Information related to resources 230 may include, for instance, type, building materials, associated people or animals, and/or other relevant information. Of course, depending on the type of resources and/or associated materials, resources 230 may also be associated with fuel information 220.

Information related to environmental conditions 240 may include, for example, wind speed and direction, humidity, temperature, atmospheric pressure, and/or other relevant information.

Information related to geography 250 may include, for example, elevation, information related to roadways 170, bodies of water 180, firebreaks, and/or other relevant geographic features.

A stochastic wildfire propagation model may be used, in which an absence of fuel results in a fire in a cell going out. Unsurprisingly, the wildfire will move in the direction of the wind, but also upslope. The resource map may help determine how to prioritize suppressive effort in time and space to reduce the extent of overall wildfire destruction.

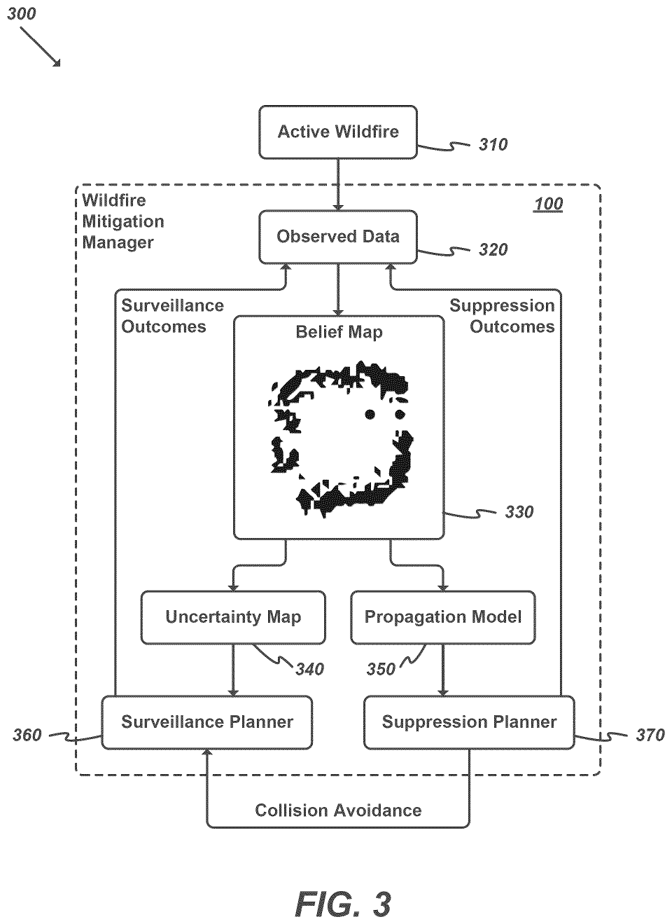

FIG. 3 illustrates a framework diagram of a hierarchical framework 300 of one or more embodiments, where surveillance and suppression planners operate in a hierarchical manner. Framework 300 depicts the links between each planner and associated outcomes related to the wildfire environment associated with an active wildfire 310. As shown, wildfire mitigation manager 100 may include, direct, utilize, and/or otherwise be associated with observed data 320, belief map 330, uncertainty map 340, propagation model 350, surveillance planner 360, suppression planner 370, and/or other appropriate elements.

Observed data 320 associated with active wildfire 310 and/or other similar event(s) may be collected by wildfire mitigation manager 100 (e.g., via surveillance agents 110). Observed data may include, for instance, image data, temperature data, weather data, environmental data, and/or other appropriate information that may be relevant to generation of a belief map 330 and/or otherwise relevant to efforts to mitigate damages caused by the active wildfire 310.

In some cases, the observed data 320 may include analysis performed at the surveillance agents 110. For example, captured image data may be analyzed at the surveillance agents 110 to determine attributes of the fire, such as position, intensity, etc. In this way, the amount of data communicated between the surveillance agents 110 and the wildfire mitigation manager 100 may be reduced.

Belief map 330 may be generated by aggregating the observed data 320. Belief map generation will be described in more detail in reference to process 1200 below. The geographic area 130 may be divided into equally sized sections (e.g., via a square grid) and a state prediction may be associated with each such section. In this example belief map 330 is represented as a binary (two-state) pixel map (where each pixel may represent one of the equally sized sections) indicating areas associated with active fire and areas that are not associated with active fire. Belief maps 330 may be represented in various other ways (e.g., a color pixel map where colors indicate intensity of fire, measured temperature, and/or some other attribute), as an outer radius or ring about a center point, and/or other appropriate ways.

Uncertainty map 340 may include one or more predictions of a current wildfire state, based on the belief map 330 (and/or observed data 320) and time elapsed since the belief map 330 was generated and/or observed data 320 was received. Thus, the uncertainty map 340 may indicate expected, possible, and/or probable current wildfire states. The uncertainty map 330 may be associated with probabilities or similar information. For example, a particular predicted state (or portion thereof) may be associated with a calculated probability (e.g., twenty percent, fifty percent, or any appropriate measure of probability). The uncertainty map may be considered a version of the belief map that reflects historical information. The uncertainty map may indicate where the belief map is least likely to be accurate due to both proximity to the fire and when the observed data was received.

The uncertainty map may be a grid, such as a rectangle including a one hundred by one hundred array of sections or cells. Each cell not associated with observation data during a particular time-step may increment the uncertainty associated with the cell by an amount proportional to proximity of the cell to one or more burning cell(s), as indicated by the belief map, for example. Each cell associated with current observation data (e.g., observation data obtained during the current time step) may reset the uncertainty associated with the cell to zero. Cells on the outskirts of a wildfire grid, for example, may have negligible likelihood of igniting and the associated uncertainties may change minimally, while cells at the head of a fire may be associated with rapidly changing uncertainty. An uncertainty model used to generate the uncertainty map may reward observations of cells that have not been recently observed more than cells that were more recently observed, regardless of whether the cell changes state post-observation.

Propagation model 350 may be generated based at least partly on the belief map 330. The propagation model may be based on attributes such as wind (e.g., direction and/or speed), elevation, available fuel 150, and/or other relevant factors. The propagation model 350 may be used during generation of a next iteration of the belief map.

Each surveillance planner 360 may be a device, system, machine learning model, user, and/or other appropriate resource or entity that is able to evaluate elements such as belief map 330 and uncertainty map 340 and generate recommendations regarding surveillance (e.g., by generating and/or identifying commands and/or instructions associated with surveillance agents 110). In some embodiments, surveillance planners 360 may pursue a goal such as reducing uncertainty, as determined via the uncertainty map 340, where the surveillance planners 360 may attempt to reduce uncertainty associated with a region (or portions thereof).

Each suppression planner 370 may be a device, system, machine learning model, user, and/or other appropriate resource or entity that is able to evaluate elements such as belief map 330 and propagation model 350 and generate recommendations regarding suppression (e.g., by generating and/or identifying commands and/or instructions associated with suppression agents 120). The suppression planners 370 may pursue goals such as reduction (e.g., by attempting to reduce a perimeter distance associated with the outer ring of the fire, by attempting to reduce total area of active burn, etc.), prevention (e.g., attempting to prevent movement of a fire along one or more paths or headings), and/or other appropriate goals (e.g., minimization of destruction or damages).

The belief map 330 may be used to generate and inform, for example, wildfire uncertainty map 340 and wildfire propagation model 350. The uncertainty map 340 may inform surveillance planner 360 (and/or a reward structure utilized by the surveillance planner 360). Surveillance planner 360 may generate surveillance outcomes that may then result in newly observed and/or collected wildfire data 320. Wildfire propagation model 350 may inform suppression planner 370 (and/or a reward structure utilized by the suppression planner 370). The suppression planner 370 may generate suppression outcomes that may result in suppressive changes to the state of active wildfire 310. For example, a drop location recommended by a suppression planner 370 may inform a surveillance planner 360 regarding locations to avoid in order to minimize the risk of collision.

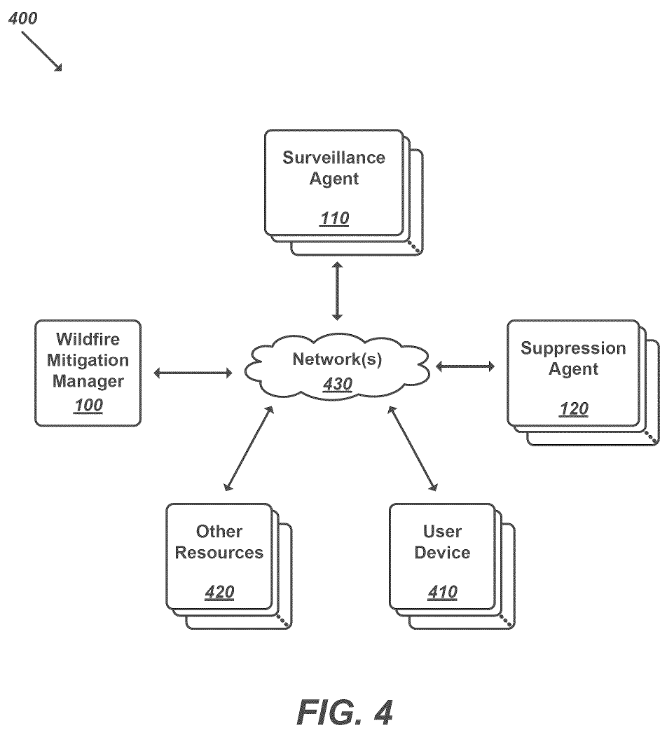

FIG. 4 illustrates a schematic block diagram of an operating environment 400 of one or more embodiments described herein. As shown, environment 400 may include wildfire mitigation manager 100, surveillance agents 110, suppression agents 120, user devices 410, other resources 420, network(s) 430, and/or other appropriate elements, components, devices, and/or systems.

Wildfire mitigation manager 100 may be, include, utilize, and/or otherwise be associated with a set of electronic components, devices, systems, and/or other appropriate elements. Wildfire mitigation manager 100 may include one or more processors that are able to execute instructions and/or otherwise manipulate data. Wildfire mitigation manager 100 may be able to communicate across networks 430. Wildfire mitigation manager 100 may be at least partially implemented using a device such as device 1500 described below. Wildfire mitigation manager 100 may be able to direct, and/or otherwise utilize, components of other devices or systems. For instance, wildfire mitigation manager 100 may provide various GUIs via a display of user device 410. As another example, wildfire mitigation manager 100 may be able to direct image capture performed by surveillance agents 110.

Wildfire mitigation manager 100 may implement a hierarchical framework, such as framework 300, which includes iterating surveillance planners 360 and suppression planners 370. The surveillance planners 360 and/or suppression planners 370 may be implemented using a formulation of tools derived from data collected from surveillance agents 110 and/or suppression agents 120 associated with environment 400. The surveillance planners 360 and/or suppression planners 370 may recommend optimized surveillance and suppression actions, which may then be transmitted to surveillance agents 110 and/or suppression agents 120 associated with environment 400.

Wildfire mitigation manager 100, and/or elements thereof, may be physically located with one or more surveillance agents 110, suppression agents 120, remote ground station (not shown), and/or other appropriate location(s) where communication among elements of environment 400 is reliable and without detrimental latency. Wildfire mitigation manager 100 may generate and store a resource such as belief map 330, based on wildfire data received from, for example, surveillance agents 110.

Each surveillance agent 110 may be an entity such as an unmanned aircraft system (UAS), a manned aircraft, another type of vehicle, a user, robot, a fixed-location camera, etc., that may be able to travel about a geographic region and collect data relevant to wildfire mitigation, such as image data, temperature data, environmental or weather data, etc. Surveillance agent 110 may be able to communicate across network 430. Surveillance agent 110 will be described in more detail below.

Each suppression agent 120 may be an entity such as a UAS, a manned aircraft, another type of vehicle, a user, robot, a fixed-location camera, etc., that may be able to travel about a geographic region and implement suppression actions, such as dropping water, deploying or building barricades or firebreaks, and/or any other actions that may mitigate wildfire spread and/or damage. Suppression agent 120 may be able to communicate across network 430. Suppression agent 120 will be described in more detail below.

Each user device 410 may be a device such as a smart phone, tablet, wearable device (e.g., a smart watch), and/or other type of device that allows user interaction with environment 400. User device 410 may be able to communicate across network 430. User device 410 may typically include various UI elements (e.g., a display, keypad, buttons, etc.) that may be used to provide information and/or instructions to a user and/or receive information and/or instructions from the user. In some cases, user devices 410 (and/or features described in association therewith) may be implemented via components of environment 400. For instance, an instantiation of suppression agent 120 may be a manned aircraft (e.g., a helicopter) that has various available UI element (e.g., displays, lights or other indicators, etc.) that may be utilized in a similar manner to a user device 410. User device 410 may be implemented using a device similar to device 1500 described below.

Each other resource 420 may be accessible via network 430 (and/or other appropriate communication pathways) and may be able to provide information to and/or receive information and/or instructions from wildfire mitigation manager 100. Examples of other resources 420 include weather information resources (e.g., a web-accessible database), map services, costing or computing resources, ground-based resources (e.g., firefighting vehicles), etc.

Network(s) 430 may include various communication pathways, such as cellular networks, satellite-based systems, radio communication channels, optical communication channels, peer-to-peer communication channels, and/or any other available communication pathways. Information such as related to observed events 140 and/or other captured data provided via surveillance agents 110 and/or suppression agents 120, map data, environmental data, planning suggestions or recommendations, machine learning models, and/or other such information may be communicated across network(s) 430.

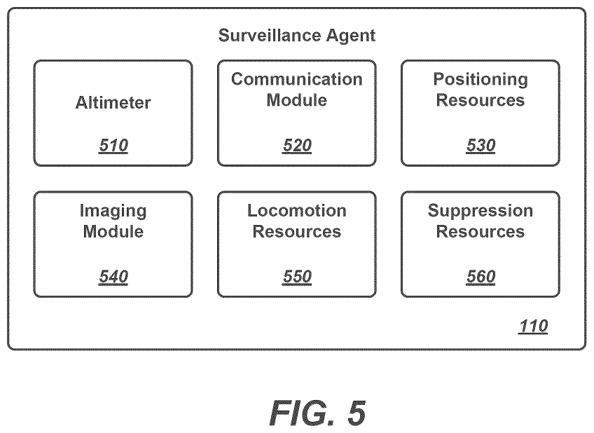

FIG. 5 illustrates a schematic block diagram of a surveillance agent 110 of one or more embodiments described herein. As shown, surveillance agent 110 may include an altimeter 510, communication module 520, positioning resources 530, imaging module 540, locomotion resources 550, suppression resources 560, and/or other appropriate resources.

Altimeter 510 and/or other such instruments (e.g., accelerometers, gyroscopes, etc.), may be, include, and/or utilize various components such as electronic components or devices that may be able to sense operating conditions of the associated surveillance agent 110. Altimeter 510 may include and/or utilize, for example, any combination of digital pressure, analogue barometric pressure, and/or differential pressure sensors, to determine altitude.

Communication module 520 may include and/or utilize components such as transceivers, interfaces, antennas, optical transmission and/or reception components, and/or other components that allow communication across network 430. Communication model 510 may be able to implement and/or utilize various messaging protocols, as appropriate. Communication module 520 may include a transceiver that is able to receive actuation commands from wildfire mitigation manager 100, and to transmit back wildfire observation data and location in three-dimensional space.

Positioning resources 530 may include or utilize components such as altimeter 510 and/or other such instruments, GPS receivers, and/or other appropriate components to determine location of the surveillance agent 110 in three-dimensional space. A GPS receiver may provide accurate location data calculated from delays in signal propagation from four or more GPS satellites. Determining with certainty the location of each surveillance agent 110 in three-dimensional space is critical to maneuvering the surveillance agents 110 in a manner that avoids collisions with one another and also with the suppression agents 120 and/or other resources.

Imaging module 540 may include and/or utilize various components, devices, and/or systems, such as cameras, light sensors, lenses, shutters, etc. Altitude has an effect on the ability of surveillance agents 110 to attain wildfire observations. By varying altitude, surveillance agents 110 may balance coverage with capture. As altitude increases, field of vision increases, and resolution quality decreases. Imaging module 540 may be able to change lenses dynamically to attain a large field of vision while achieving excellent resolution. Imaging module 540 may include one or more cameras strategically positioned to observe the propagating wildfire below (and/or other relevant information). Multiple cameras positioned in various locations may allow for the collection of uniform data that is not forward-facing. Imaging module 540 need not necessarily operate in, or only in, the visual light spectrum, and may further allow for infrared thermography, to include short wavelength infrared (SWIR), medium wavelength infrared (MWIR), and long wavelength infrared (LWIR). Imaging module 540 may apply night vision light intensification, which amplifies existing visible light.

In addition to, or in place of, such optical sensors, surveillance agent 110 may include and/or utilize other types of sensors, such as temperature sensors, environmental sensors, etc.

Locomotion resources 550 may include and/or utilize various components, devices, and/or systems that are able to manipulate the position of the surveillance agent 110 in three-dimensional space. For example, surveillance agent 110 may be an unmanned aircraft that includes any form of aerial locomotion actuator, whether fixed-wing or rotor-based (or a combination of the two). Surveillance agent 110 may utilize locomotion resources 550 to continually adjust position, using, for example, a self-contained processor and memory, such that actuation commands received from wildfire mitigation manager 100 may be implemented autonomously.

Suppression resources 560 may include features such as, for example, a suppression actuator, a water bucket, fire retardant tank with hose, or even human smokejumpers and rappelers.

Surveillance agent 110 may include various UI resources similar to UI resources 670 described below.

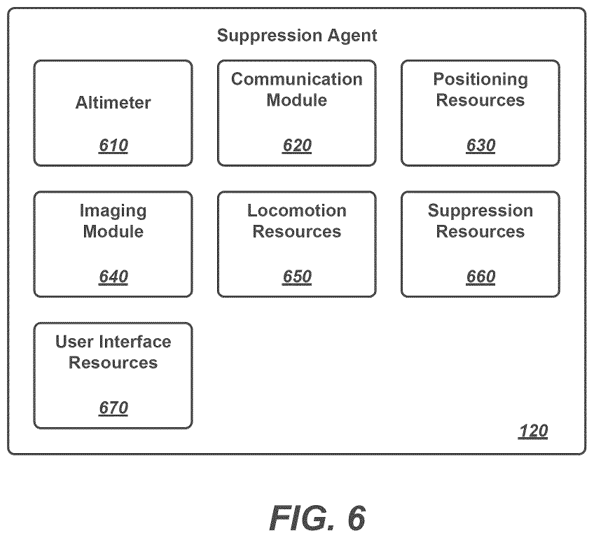

FIG. 6 illustrates a schematic block diagram of a suppression agent 120 of one or more embodiments described herein. As shown, suppression agent 120 may include an altimeter 610, communication module 620, positioning resources 630, imaging module 640, locomotion resources 650, suppression resources 660, user interface (UI) resources 670, and/or other appropriate resources.

Altimeter 610 and/or other such instruments may be similar to altimeter 510 and other such instruments described above in reference to surveillance agent 110.

Communication module 620 may be similar to communication module 520.

Positioning resources 630 may be similar to positioning resources 530.

Imaging module 640 may be similar to imaging module 540.

Locomotion resources 650 may be similar to locomotion resources 550.

Suppression resources 660 may be similar to suppression resources 560 described above.

UI resources 670 may include various displays, indicators, keypads, speakers, microphones, etc. that may be used to interact with a user. UI Resources 670 may be implemented using one or more user devices 410. Manned aircraft may be associated with one or more aviators capable of controlling locomotion resources 650 in accordance with suppression commands or instructions received from wildfire mitigation manager 100 via communication module 620 and displayed via UI resources 670 or user device 410, but also in accordance with domain best practices and operating procedures, state and federal regulations, and personal expertise. Manned aircraft thus may be capable of deviating from the guidance provided by wildfire mitigation manager 100. Therefore, planners associated with wildfire mitigation manager 100 (e.g., surveillance planner 360 and/or suppression planner 370) must ensure that unmanned aircraft are responsive to the location of manned aircraft at all times, with awareness that issued suppression recommendations to manned aircraft may not always be executed.

Although various components have been described as surveillance agents 110 or suppression agents 120, one of ordinary skill in the art will recognize that, depending on the capabilities of each agent, surveillance agents 110 may perform suppression activities, while suppression agents 120 may perform surveillance activities.

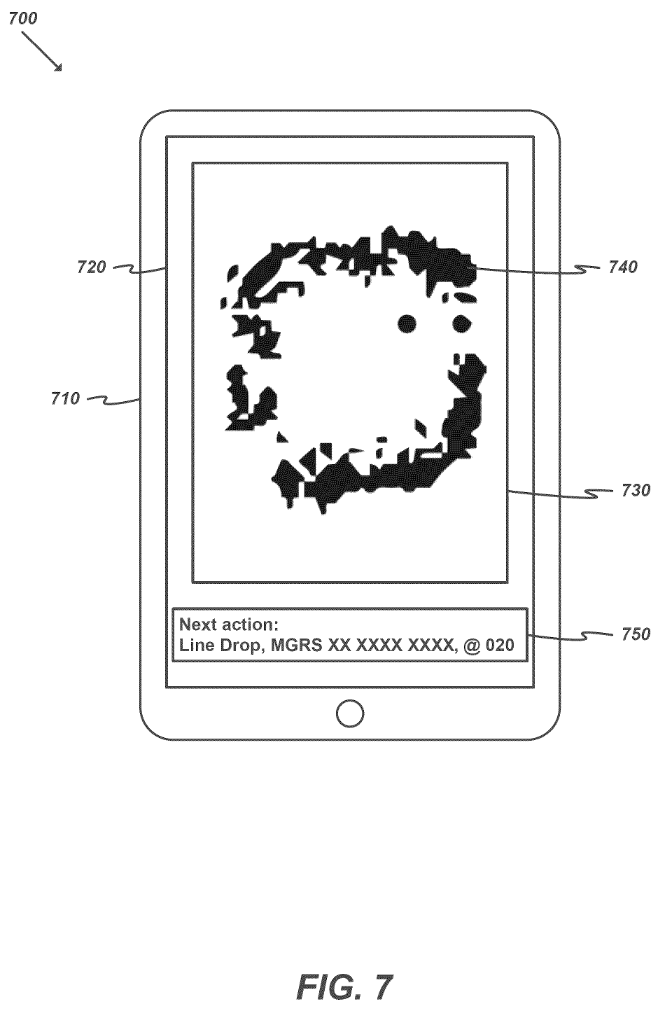

FIG. 7 illustrates an example graphical user interface (GUI) 700 of one or more embodiments described herein, where information related to a wildfire is provided to aircraft crew. In this example, GUI 700 is presented via a user device 410 having a display 710. As shown, GUI 700 may include a wildfire state display area 720 (showing an example wildfire state representation 730 in this example), an instruction or command area 740, and/or other appropriate elements.

User device 410 may be a device such as a cell phone, tablet (e.g., as commonly carried by aviators as part of a kneeboard assembly), wearable device, and/or other type of device able to provide data to, and/or receive data from, a user. Depending on the crew configuration, the aviator may be solely responsible for flying the aircraft while a fire or crew chief executes the suppressive activity. In such cases, both the individual controlling locomotion and the individual controlling suppression may have access to GUI 700 (e.g., by utilizing multiple user devices 410 or a shared user device 410).

Display 710 may be, include, and/or utilize electronic components able to provide visual information such as graphics, text, and/or multimedia. Wildfire state display area 720 may include a visual representation of the current wildfire state. Example wildfire state representation 730 may be generated based on a current belief map received from wildfire mitigation manager 100, such as belief map 330.

Instruction or command area 740 may include text-based instructions or commands and/or other information, as shown. Different embodiments may include various different features than text. For instance, graphics such as icons or differently colored (or otherwise differently styled) text may indicate different types of data and/or discrete values thereof. In this example, the instruction or command area 740 indicates the optimal location of the next drop, the drop type, and the direction (e.g., point drop or line drop: NS, EW, NW, NE). User device 410 may be integrated into an avionics package associated with an aircraft (e.g., surveillance agent 110 or suppression agent 120) to establish the location of the next recommended action as a waypoint. In this way, a user such as an aviator may have immediate knowledge and visibility of upcoming actions and be able to establish a proper aircraft entry procedure accordingly.

Other elements may include user input features, such as keypads, keyboards, buttons, touchscreens, touchpads, etc. Other visual elements may include selectable features such as buttons or menus. For example, a user may be able to type observed information via a keyboard or virtual keyboard. As another example, a user may be able to adjust display parameters or attributes using various GUI features.

In this example, GUI 700 may be presented to personnel such as an aviator and/or other crew of a manned aircraft 120 in order to inform the users of the current wildfire state and recommended action. Similar GUIs may be presented to other types of entities, such as surveillance planners 360 and/or suppression planners 370. The GUIs of some embodiments may be presented through various resources other than, or in conjunction with, user device 410. For example, a GUI such as GUI 700 may be presented to an aviator via a heads-up display associated with a flight helmet. GUI 700 may include, and/or otherwise be associated with, other types of interfaces than visual. For instance, data may be provided through a speaker and/or responses received via a microphone. As another example, haptic feedback may be used to alert a user to updated data or a newly received command or instruction.

GUI 700 may be rendered in various appropriate ways, depending on relevant factors such as display attributes (e.g., size, resolution, etc.), user device attributes (e.g., type, hardware capabilities, etc.), etc.

One of ordinary skill in the art will understand that GUI 700 is presented for exemplary purposes and that various other GUIs (and/or UIs) may be presented depending on the entity type, interface capabilities, device type, and/or other relevant factors. For instance, a similar GUI may be presented to users associated with surveillance planner 360 and/or suppression planner 370 in order to aid generation of surveillance outcomes and/or suppression outcomes. As another example, a GUI may be optimized for a user such as a pilot, where the GUI may be rendered for display via a helmet or heads-up display and/or may include other information, such as position information (e.g., altitude, bearing, location, etc.), information indicating position of other aircraft, and/or other relevant information (e.g., fuel level or range).

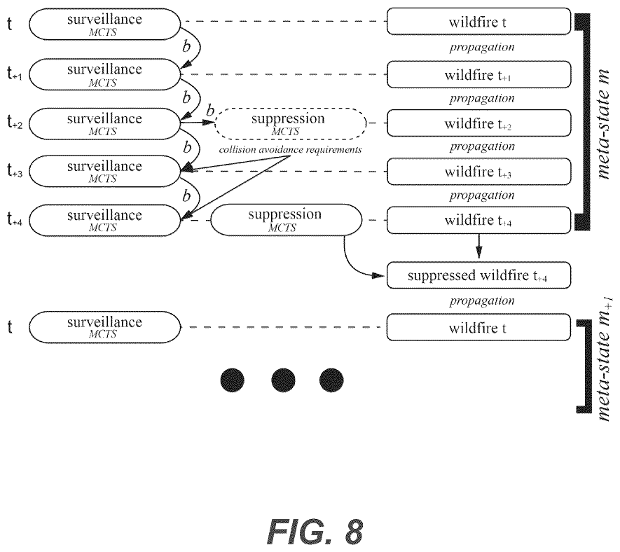

FIG. 8 illustrates a temporal flow diagram of one or more embodiments, where surveillance and suppression planning may be performed iteratively and asynchronously. At each time-step t, a surveillance planner associated with the wildfire mitigation manager 100 may determine a next command or instruction associated with one or more agents 110 or 120 in order to attain additional wildfire observations and update an overall belief map b. The surveillance planner is here modeled as a Markov decision process (MDP), and Monte Carlo tree search (MCTS) may be used to determine an optimal action and/or sequence of actions. An initial action may be executed, and belief map b may be passed to the next iteration of the surveillance planner. The wildfire propagation is shown here in discrete form, but actually evolves continuously. There are numerous surveillance reward models that may be used with the surveillance MDP, such as an uncertainty model. The uncertainty model may reward, for example, surveillance agent 110 movements that reduced the overall uncertainty of belief map b, regardless of where the wildfire is or is not. Such an approach requires the generation of an internally maintained uncertainty map. The suppression planner may also be modeled as an MDP, and MCTS may be used to determine an optimal action and/or sequence of actions. In this depiction, each suppression action may be calculated and acted upon once every five time-steps. The suppression model may feed the current belief map b into an internal wildfire propagation model that may be used with a resource destruction minimization reward model to determine the optimal suppression location and drop type. The exact model of planner and solver may be easily varied without changing the critical components as described herein.

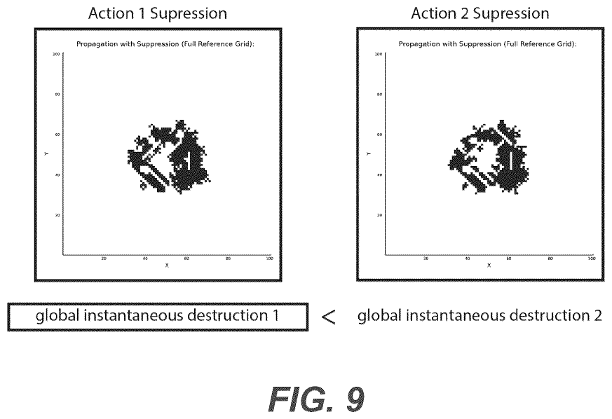

FIG. 9 illustrates a reward model diagram of one or more embodiments, where suppression planners, such as suppression planner 370, pursue a goal of minimization of global resource destruction. Global resource destruction minimization allows for the direct comparison of any action taken across the global grid following the appropriate propagation sequence. However, the scope of destruction often causes the impact of the selected suppression activity to get lost amid the extent of the stochastic fire spread. The wildfire belief map may be suppressed with various actions, with each result propagated between five and fifteen times. The post-suppression propagation grids may be compared on a global level to determine an action consequence. The smaller the instantaneous destruction, the greater the action impact.

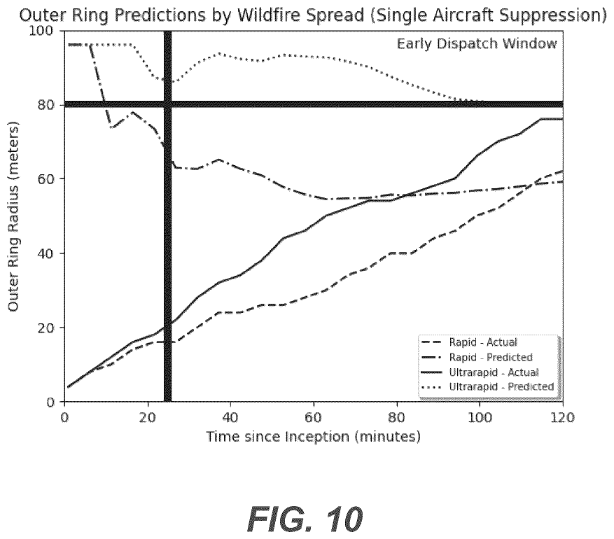

FIG. 10 illustrates a two-dimensional plot of one or more embodiments, where the accuracy of wildfire predictions is indicated. Outer ring predictions generated using regression statistics over the wildfire belief map developed through intertwined surveillance and suppression activities may be compared to actual outcomes to evaluate accuracy. The development of an intertwined surveillance-suppression model via the wildfire mitigation manager 100 enables the early allocation of additional suppression assets in instances where wildfire growth exceeds even the optimized capabilities of a single aircraft. Challenges include when to call for additional assets, and what thresholds should determine that additional assets are required. The vast majority of initial attack fires do not become escaped fires, and premature dispatching of aircraft is therefore costly and wasteful. At the same time, initial attack fires destined to become escaped fires have limited windows of opportunity in which additional suppression can result in containment; after a certain point, the wildfire spread is too significant to be reasonably contained except by a full-blown suppression operation. A regression-backed approach is introduced, wherein the wildfire ring radius (and/or some other attributed associated with specified deployment criteria) at one hundred twenty minutes after inception is predicted at each time-step t in which suppression is executed. If the predicted wildfire ring radius exceeds a given time and ring threshold (and/or other deployment criteria), then a second manned aircraft is dispatched to the scene to conduct suppression activities. Deployment criteria may include, for example, outer ring radius, total active burn area, spread rate, and/or other relevant criteria.

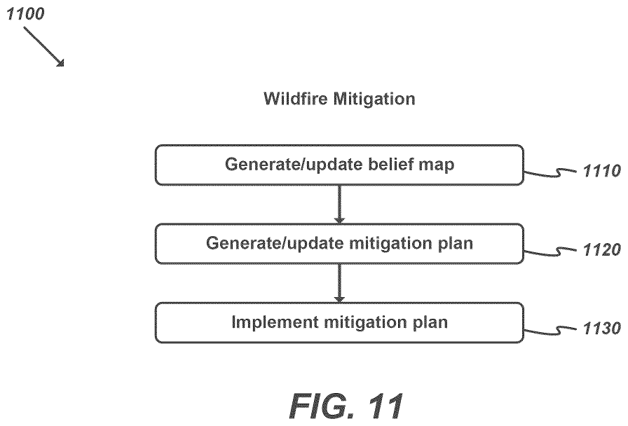

FIG. 11 illustrates an example process 1100 for mitigating wildfire damage. Process 1100 may monitor a wildfire state, identify mitigating actions as appropriate, and implement the mitigation actions. The process may be performed whenever an active wildfire is identified, during surveillance of a particular area, and/or under other appropriate circumstances. In some embodiments, process 1100 may be performed by wildfire mitigation manager 100.

As shown, process 1100 may include generating (at 1110) a belief map. As described above, wildfire mitigation manager 100 may receive surveillance data and/or other data from various appropriate entities, such as surveillance agents 110, suppression agents 120, user devices 410, other resources 420, and/or other appropriate agents or resources. Such surveillance data may include image data, temperature data, environmental and/or weather data, position data (e.g., position of a surveillance agent 110 when capturing image data as indicated using altitude and GPS coordinates, for example), and/or other relevant data. The surveillance data may be aggregated and/or filtered to form a belief map, such as belief map 330, indicating a current state of the wildfire, where a current state also includes the possibility of no active fire or no active risk of fire. Wildfire mitigation manager 100 may also generate resources such as an uncertainty map (e.g., uncertainty map 340) and/or propagation model 350) based on the belief map.

Process 1100 may include generating (at 1120) a mitigation plan. Based on the belief map and/or other relevant information (e.g., availability and/or location of surveillance agents 110 and/or suppression agents 120) a mitigation plan may be generated by resources such as surveillance planners 360 and/or suppression planners 370. The surveillance planners 360 and/or suppression planners 370 may pursue a goal of, for example, minimizing total damage. The wildfire mitigation manager 100 may manage or optimize the mitigation plan by, for example, modifying flight paths of surveillance agents 110 based on flights paths associated with suppression agents 120.

In some embodiments, the mitigation plan may include listings of commands or instructions for surveillance agents 110, suppression agents 120, and/or other resources or agents. Each command may be associated with various relevant information or attributes, such as associated agent, priority level, expected start time, expected time of completion, location, dependencies, etc. Such commands may include, for instance, instructions for unmanned agents to move to a particular position and capture image data and/or perform suppression actions. Each command or instruction may be associated with a specific agent, and/or may be provided in a generic queue for the next available, or most appropriate agent, where the appropriate agent may be selected based on various relevant factors (e.g., current position, fuel level or range, capabilities of the agent, etc.).

The commands may include, or be associated with, various dependencies, and/or may include multiple components. For example, if a suppression agent 120 is tasked to perform a first suppressive action and then a second suppressive action, the suppression agent 120 may have to resupply before performing the second suppressive action (e.g., by dipping water at pond or other body of water 180, by travelling to a base station for re-supply, etc.).

The mitigation plan may include various thresholds and/or triggers for various actions. For instance, if the outer ring of a belief map is larger than a specified threshold, additional resources may be deployed and/or actions may be requested.

The mitigation plan may include priority levels or other rankings of areas or sections of the geographic area 130. As an example, areas rich in fuel 150 or associated with resources 160 may be prioritized when requesting or implementing actions (e.g., if an observed event 140 occurs in a higher priority area, a response may be prioritized relative to an earlier observed event 310 associated with a lower priority area (e.g., an area less rich in fuel 150 or associated with fewer resources 160). In some embodiments, an area of interest, such as geographic area 130 may be automatically divided into sections (e.g., by dividing the area into a number of square or rectangles, by dividing the area into amorphous sections based on analysis of terrain, etc.) and each section may be associated with information such as observed events 140, available fuel 150, resources 160, geographic features 170, bodies of water 180, etc. associated with a location that at least partially overlaps, is near to, and/or is otherwise associated with each section.

The process may include implementing (at 1130) the mitigation plan. Such implementation may include, for example, identifying a next command or instruction (e.g., based on priority, difficulty of implementation, and/or other relevant factors). The next command or instruction may be identified using a machine learning model or other automated decision-making resource. The wildfire mitigation manager 100 may provide the next command or instruction to the appropriate surveillance agent 110 and/or suppression agent 120. The wildfire mitigation manager 100 may receive confirmation that the actions have been completed (e.g., via sets of messages transferred between the wildfire mitigation manager 100 and the agent), may determine that the actions have been completed based on received information (e.g., a request for image capture may be determined to be completed when image data is received), and/or may direct an available agent to capture image data and/or other data that may be used to verify the action.

In some embodiments, surveillance agents 110 and/or suppression agents 120 may be associated with crew members and/or have on-board analysis capabilities. In such cases, the wildfire mitigation manager 100 may send updated belief maps, uncertainty maps, and/or propagation models to such agents in addition to, or in place of, any commands and/or instructions. In such cases, the agents may be able to adjust their actions based on relevant factors such as locally observed data, changing conditions, etc.

During implementation of the mitigation plan, the wildfire mitigation manager 100 may monitor airspace and provide commands and/or instructions to the surveillance agents 110 and/or suppression agents 120 in order to avoid collisions or other interference.

Process 1100 may iteratively perform operations 1110-1130, by updating (at 1110) the belief map, updating (at 1120) the mitigation plan, and implanting (at 1130) the updated mitigation plan as long as an event is active and/or based on some other criteria (e.g., periodic monitoring of a region to determine whether new events have occurred, completion of a command or suppressive action, etc.). The operations 1110-1130 may be implemented at regular intervals (e.g., every one minute) in some embodiments.

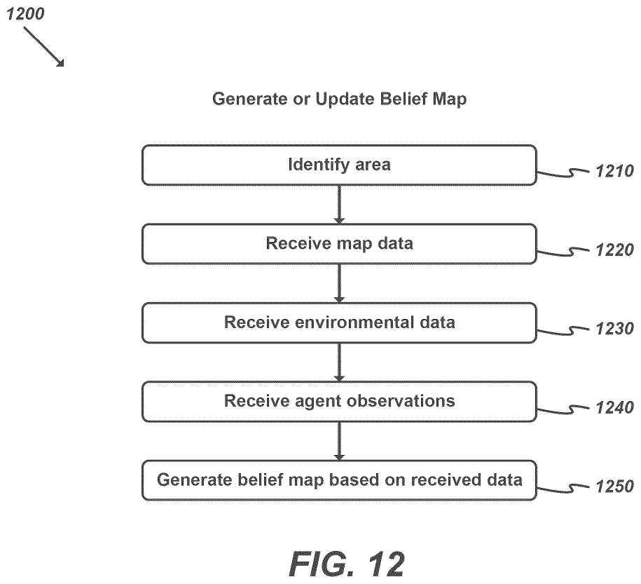

FIG. 12 illustrates an example process 1200 for generating or updating a belief map. The process may collect data from agents and/or other resources and provide a current wildfire state of a region, such as geographic region 130. The process may be performed whenever a belief map is requested or required, such as operation 1110 above. In some embodiments, process 1200 may be performed by wildfire mitigation manager 100.

As shown, process 1200 may include identifying (at 1210) an area. Such an area may be similar to geographic area 130 described above. The area may be identified and/or defined in various appropriate ways. For example, in some cases a wildfire mitigation manager 100 may be associated with one or more such geographic areas 130, and may continuously or periodically monitor the area. As another example, an area may be identified or defined based on an event. If an observed event 140 is received by the wildfire mitigation manager 100, an area may be defined relative to the location of the observed event 140, such as by selecting a section from a pre-defined grid, generating a perimeter about the location of the observed event 140, and/or other appropriate ways. The area may be defined using various coordinates, vectors, and/or magnitudes, as appropriate. For instance, a rectangular area may be defined using four points (as specified using GPS coordinates, for example). As another example, a circular area may be defined using a center point and radius.

Process 1200 may include receiving (at 1220) map data. If available, map data for the identified area may be received from an appropriate resource, such as a storage associated with wildfire mitigation manager 100. Map data may be received from other resources 420 such as public or private map databases, via a channel such as network(s) 430. Map data may include information such as, for example, location, size, orientation, and/or path of elements such as fuel 150, resources 160, geographic features 170, bodies of water 180, etc. Map data may include elevation information and/or other information regarding terrain. If map data is not available, map data may be generated based on analysis of captured image data, agent position information, and/or other relevant information. In some cases, if map data is not available, a default space may be defined or a space may be defined based on the positions associated with, for example, observed data 320 (e.g., the outermost positions may be identified and used to define a rectangle or other polygon).

The process may include receiving (at 1230) environmental data. Environmental data may include data such as temperature, wind speed and direction, humidity, precipitation, atmospheric pressure, visibility, and/or other relevant information. Environmental data may be received from various appropriate resources, such as surveillance agents 110, suppression agents 120, other resources 420 (e.g., an online weather service, local sensors or devices, etc.), etc. For example, surveillance agents 110 and/or suppression agents 120 may include, utilize, and/or otherwise be associated with sensors such as temperature sensors, wind sensors, etc. and measurement information may be sent to wildfire mitigation manager 100 in a comparable manner to information related to observed events 140.

As shown, process 1200 may include receiving (at 1240) agent observations. Agents such as surveillance agents 110, suppression agents 120, and/or other appropriate agents may send messages (or similar packages of information) to wildfire mitigation manager 100 via a resource such as network(s) 430. Such messages may include information related to observed events 140 (if the agent is able to identify such events autonomously), and/or other information, such as captured image data (and/or other observational data), captured environmental data (e.g., wind speed and direction, temperature, humidity, etc.), current location (e.g., as indicated by GPS coordinates and altitude), results of on-board analysis, etc. Agent observations may include confirmation of completion of assigned tasks or commands (e.g., a suppression agent 120 may send a completion message including location and/or other relevant information when a suppressive action has been completed).

Process 1200 may include generating (at 1250) a belief map based on the received data. The belief map, such as represented by belief map 330, may be generated by analyzing, aggregating, and/or filtering agent observation data. For example, received image data may be analyzed to identify geographic features and/or observed events 140. Areas associated with observed events 140 may be indicated on the belief map via a bitmap or similar representation that indicates areas associated with the observed events 140 (e.g., active fire cells) and areas not associated with the observed events 140 (e.g., areas with no fire activity).

The space associated with geographic area 130 may be analyzed to generate a probability distribution over the space, where probabilities of various current states may be determined. In a simple form, such states may include, for example, “active” and “inactive” to provide a binary indicator as to whether an active fire cell is predicted at a particular location. As another example, states may be defined along a discrete scale indicating severity of a fire (e.g., on scale of one to ten, where one indicates no fire and ten indicates raging fire). The geographic area 130 may be divided into equally sized sections (e.g., via a square grid) and a state prediction may be associated with each such section.

In addition to the belief map, an uncertainty map and/or propagation model may be generated for use by the surveillance planners 360 and/or suppression planners 370.

Operations 1230-1250 may be performed iteratively, while a belief map is being utilized. As newly captured observations are received, the belief map, uncertainty map, and/or propagation model may be updated.

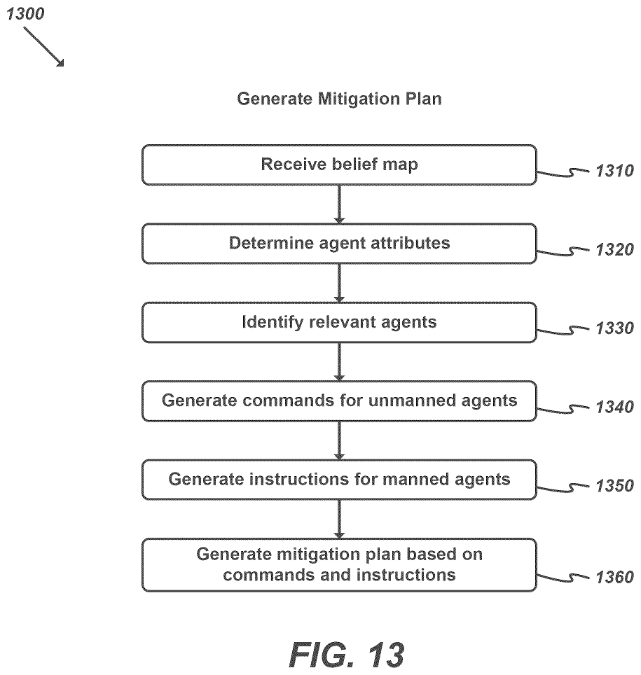

FIG. 13 illustrates an example process 1300 for generating a mitigation plan. The belief map, uncertainty map, and/or propagation model may be used to generate a mitigation plan. The mitigation plan may include instructions and/or commands for the various agents that may be structured in a time-dependent and/or otherwise prioritized list. The process may be performed whenever a mitigation map is requested or required, such as operation 1120 above. In some embodiments, process 1300 may be performed by wildfire mitigation manager 100.

As shown, process 1300 may include receiving (at 1310) a belief map. Such a belief map may be generated using a process such as process 1200.

Process 1300 may include determining (at 1320) agent attributes. Wildfire mitigation manager 100 may maintain a listing of available agents and associated attributes, such as whether the agents have provided observations within some time window (e.g., within the last hour), agent status (e.g., location, fuel level or range, task queue, etc.), and/or other relevant attributes (e.g., agent type, capabilities, etc.). For newly discovered agents, and/or agents with incomplete or stale information, wildfire mitigation manager 100 may send an update request and/or otherwise collect updated attribute information (e.g., updated location, status, task queue, etc.).

The process may include identifying (at 1330) relevant agents. Based on the belief map, uncertainty map, propagation model, and/or other appropriate information, the wildfire mitigation manager 100 may identify agents relevant to the mitigation plan. Relevant agents may be identified based on factors such as type of action required, status, location, capability, existing task queue, etc.

As shown, process 1300 may include generating (at 1340) commands for unmanned agents. Such commands may include information such as task type(s) (e.g., image capture, collect environmental data, perform suppressive action, etc.), location (e.g., GPS position and altitude), flight path or similar information, and/or other relevant information (e.g., location or flight path information associated with nearby agents). A listing of tasks, associated priority, and/or other relevant information may be generated by analyzing the belief map (and/or associated uncertainty map and/or propagation model), status of agents, and/or other relevant information, and identifying actions most likely to meet the operational goal (e.g., minimization of damages). A listing of commands may be generated based on the listing of tasks using resources such as surveillance planners 360 and/or suppression planners 370. The listing of commands may be analyzed to match commands to available unmanned agents with the required capabilities to execute the commands.

Process 1300 may include generating (at 1350) instructions for manned agents. As above, the listing of tasks may be analyzed to match instructions to available manned agents with the required capabilities to execute the tasks. A listing of instructions to manned agents may be generated based on the listing of tasks using resources such as surveillance planners 360 and/or suppression planners 370. Each instruction may include a listing of data to be provided to the agents (e.g., a belief map, uncertainty map, and/or propagation model may be sent to the agents with the instructions) such that the agents may act at least partially autonomously in an informed manner.

The wildfire mitigation manager 100 may generate expected positions of the suppression agents 120 (e.g., instructions or guidance sent to the suppression agent 120, based on previously known positions, and/or otherwise determined). The expected positions may be adjusted or “dialed in” as the suppression agent 120 maneuvers around the wildfire. Thus, if the wildfire mitigation manager 100 makes a recommendation (e.g., via some guidance instructions sent to the suppression agent 120), it is important to recognize that the suppression agent 120 (when implemented via a manned system) may choose to ignore the recommendation. In such cases, the model may be updated in real-time as the suppression agent 120 operates independently.

The process may include generating (at 1360) a mitigation plan based on the tasks. The mitigation plan may include a listing of commands and instructions, an agent associated with each command or instruction, information related to implantation of the plan (e.g., expected task start time, expected task completion time, actual task start time, actual task completion time, etc.). The mitigation plan may include a listing of agents, crews, and/or other personnel or resources (e.g., surveillance planners 360 and/or suppression planners 370) associated with the plan.

Process 1300 may be performed iteratively, each time an updated belief map is generated and/or based on other appropriate criteria (e.g., receiving information from agents).

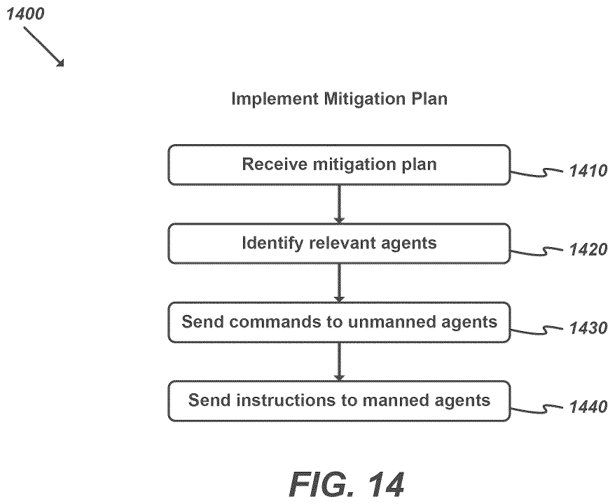

FIG. 14 illustrates an example process 1400 for implementing a mitigation plan. The process may be performed whenever a mitigation plan is generated or updated. In some embodiments, process 1400 may be performed by wildfire mitigation manager 100.

As shown, process 1400 may include receiving (at 1410) a mitigation plan. The mitigation plan may be generated using a process such as process 1300.

Process 1400 may include identifying (at 1420) relevant agents. As described above, the mitigation plan may include a listing of associated agents. Alternatively, wildfire mitigation manager 100 may identify relevant agents based on the requirements of the mitigation plan and the status of agents known to the wildfire mitigation manager 100.

In some embodiments, agent allocation (e.g., deployment of additional agents) may be managed by the wildfire mitigation manager 100 based on the belief map, uncertainty map, propagation model, and/or other relevant factors. For instance, the belief map, uncertainty map, and propagation model may be used to generate a set of outer ring predictions. The outer ring predictions may be compared to one or more response thresholds (e.g., a first outer ring threshold may be associated with deployment of a single agent, a second outer ring threshold may be associated with deployment of one or more additional agents, etc.). Agents may then be deployed or recalled based on the identified response threshold(s). In some cases, deployment of agents may include sending a customized request from the wildfire mitigation manager 100 to a dispatch facility or similar resource indicating agents required to perform suppression activity.

The process may include sending (at 1430) commands to unmanned agents. Such commands may include, for instance, guidance or navigation commands (e.g., specifying a location and/or flight path). The commands may include instructions or tasks (e.g., capture images, record sensor data, perform suppressive action, etc.) to be performed by the agents. The process may receive responses or other confirmation from the agents and/or other resources.

As shown, process 1400 may include sending (at 1440) instructions to manned agents. Such commands may include, for instance, guidance or navigation commands (e.g., specifying a location and/or flight path). The commands may include instructions or tasks (e.g., capture images, record sensor data, perform suppressive action, etc.) to be performed by the agents. The process may receive responses or other confirmation from the agents and/or other resources.

Process 1400 may be performed iteratively, each time an updated mitigation plan is generated and/or based on other appropriate criteria (e.g., receiving information from agents).

One of ordinary skill in the art will recognize that processes 1100-1600 may be implemented in various different ways without departing from the scope of the disclosure. For instance, the elements may be implemented in a different order than shown. As another example, some embodiments may include additional elements or omit various listed elements. Elements or sets of elements may be performed iteratively and/or based on satisfaction of some performance criteria. Non-dependent elements may be performed in parallel. Elements or sets of elements may be performed continuously and/or at regular intervals.

The processes and modules described above may be at least partially implemented as software processes that may be specified as one or more sets of instructions recorded on a non-transitory storage medium. These instructions may be executed by one or more computational element(s) (e.g., microprocessors, microcontrollers, digital signal processors (DSPs), application-specific integrated circuits (ASICs), field programmable gate arrays (FPGAs), other processors, etc.) that may be included in various appropriate devices in order to perform actions specified by the instructions.

As used herein, the terms “computer-readable medium” and “non-transitory storage medium” are entirely restricted to tangible, physical objects that store information in a form that is readable by electronic devices.

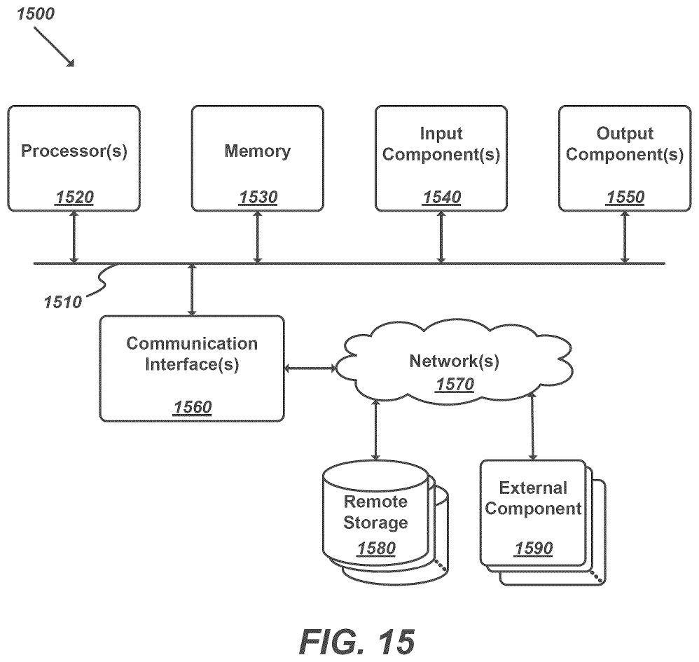

FIG. 15 illustrates a schematic block diagram of an exemplary device (or system or devices) 1500 used to implement some embodiments. For example, the systems, devices, components, and/or operations described above in reference to FIG. 1, FIG. 2, FIG. 3, FIG. 4, FIG. 5, FIG. 6, FIG. 7, FIG. 8, FIG. 9, and FIG. 10 may be at least partially implemented using device 1500. As another example, the processes described in reference to FIG. 11, FIG. 12, FIG. 13, and FIG. 14 may be at least partially implemented using device 1500.

Device 1500 may be implemented using various appropriate elements and/or sub-devices. For instance, device 1500 may be implemented using one or more personal computers (PCs), servers, mobile devices (e.g., smartphones), tablet devices, wearable devices, and/or any other appropriate devices. The various devices may work alone (e.g., device 1500 may be implemented as a single smartphone) or in conjunction (e.g., some components of the device 1500 may be provided by a mobile device while other components are provided by a server).

As shown, device 1500 may include at least one communication bus 1510, one or more processors 1520, memory 1530, input components 1540, output components 1550, and one or more communication interfaces 1560.

Bus 1510 may include various communication pathways that allow communication among the components of device 1500. Processor 1520 may include a processor, microprocessor, microcontroller, DSP, logic circuitry, and/or other appropriate processing components that may be able to interpret and execute instructions and/or otherwise manipulate data. Memory 1530 may include dynamic and/or non-volatile memory structures and/or devices that may store data and/or instructions for use by other components of device 1500. Such a memory device 1530 may include space within a single physical memory device or spread across multiple physical memory devices.

Input components 1540 may include elements that allow a user to communicate information to the computer system and/or manipulate various operations of the system. The input components may include keyboards, cursor control devices, audio input devices and/or video input devices, touchscreens, motion sensors, etc. Output components 1550 may include displays, touchscreens, audio elements such as speakers, indicators such as light-emitting diodes (LEDs), printers, haptic or other sensory elements, etc. Some or all of the input and/or output components may be wirelessly or optically connected to the device 1500.

Device 1500 may include one or more communication interfaces 1560 that are able to connect to one or more networks 1570 or other communication pathways. For example, device 1500 may be coupled to a web server on the Internet such that a web browser executing on device 1500 may interact with the web server as a user interacts with an interface that operates in the web browser. Device 1500 may be able to access one or more remote storages 1580 and one or more external components 1590 through the communication interface 1560 and network 1570. The communication interface(s) 1560 may include one or more application programming interfaces (APIs) that may allow the device 1500 to access remote systems and/or storages and also may allow remote systems and/or storages to access device 1500 (or elements thereof).

It should be recognized by one of ordinary skill in the art that any or all of the components of computer system 1500 may be used in conjunction with some embodiments. Moreover, one of ordinary skill in the art will appreciate that many other system configurations may also be used in conjunction with some embodiments or components of some embodiments.

In addition, while the examples shown may illustrate many individual modules as separate elements, one of ordinary skill in the art would recognize that these modules may be combined into a single functional block or element. One of ordinary skill in the art would also recognize that a single module may be divided into multiple modules.

Device 1500 may perform various operations in response to processor 1520 executing software instructions stored in a computer-readable medium, such as memory 1530. Such operations may include manipulations of the output components 1550 (e.g., display of information, haptic feedback, audio outputs, etc.), communication interface 1560 (e.g., establishing a communication channel with another device or component, sending and/or receiving sets of messages, etc.), and/or other components of device 1500.

The software instructions may be read into memory 1530 from another computer-readable medium or from another device. The software instructions stored in memory 1530 may cause processor 1520 to perform processes described herein. Alternatively, hardwired circuitry and/or dedicated components (e.g., logic circuitry, ASICs, FPGAs, etc.) may be used in place of or in combination with software instructions to implement processes described herein. Thus, implementations described herein are not limited to any specific combination of hardware circuitry and software.

The actual software code or specialized control hardware used to implement an embodiment is not limiting of the embodiment. Thus, the operation and behavior of the embodiment has been described without reference to the specific software code, it being understood that software and control hardware may be implemented based on the description herein.

While certain connections or devices are shown, in practice additional, fewer, or different connections or devices may be used. Furthermore, while various devices and networks are shown separately, in practice the functionality of multiple devices may be provided by a single device or the functionality of one device may be provided by multiple devices. In addition, multiple instantiations of the illustrated networks may be included in a single network, or a particular network may include multiple networks. While some devices are shown as communicating with a network, some such devices may be incorporated, in whole or in part, as a part of the network.

Some implementations are described herein in conjunction with thresholds. To the extent that the term “greater than” (or similar terms) is used herein to describe a relationship of a value to a threshold, it is to be understood that the term “greater than or equal to” (or similar terms) could be similarly contemplated, even if not explicitly stated. Similarly, to the extent that the term “less than” (or similar terms) is used herein to describe a relationship of a value to a threshold, it is to be understood that the term “less than or equal to” (or similar terms) could be similarly contemplated, even if not explicitly stated. Further, the term “satisfying,” when used in relation to a threshold, may refer to “being greater than a threshold,” “being greater than or equal to a threshold,” “being less than a threshold,” “being less than or equal to a threshold,” or other similar terms, depending on the appropriate context.

No element, act, or instruction used in the present application should be construed as critical or essential unless explicitly described as such. An instance of the use of the term “and,” as used herein, does not necessarily preclude the interpretation that the phrase “and/or” was intended in that instance. Similarly, an instance of the use of the term “or,” as used herein, does not necessarily preclude the interpretation that the phrase “and/or” was intended in that instance. Also, as used herein, the article “a” is intended to include one or more items and may be used interchangeably with the phrase “one or more.” Where only one item is intended, the terms “one,” “single,” “only,” or similar language is used. Further, the phrase “based on” is intended to mean “based, at least in part, on” unless explicitly stated otherwise.

The foregoing relates to illustrative details of exemplary embodiments and modifications may be made without departing from the scope of the disclosure. Even though particular combinations of features are recited in the claims and/or disclosed in the specification, these combinations are not intended to limit the possible implementations of the disclosure. In fact, many of these features may be combined in ways not specifically recited in the claims and/or disclosed in the specification. For instance, although each dependent claim listed below may directly depend on only one other claim, the disclosure of the possible implementations includes each dependent claim in combination with every other claim in the claim set.

1. A device, comprising:
one or more processors configured to:
receive, at a wildfire mitigation manager, from a surveillance agent, observation data and surveillance agent position data;
generate, based at least partly on the observation data and the surveillance agent position data, a belief map;
generate, based at least partly on the belief map and the surveillance agent position data, a guidance command;
send, to the surveillance agent, the guidance command;
generate, based at least partly on the belief map, a suppression command; and
send, to a suppression agent, the suppression command.

2. The device of claim 1, wherein the surveillance agent is an unmanned aircraft and wherein the suppression agent is a manned aircraft.

3. The device of claim 1, wherein the surveillance agent position data comprises altitude and global positioning system (GPS) data, wherein the guidance command comprises a first target location and wherein the suppression command comprises a second target location, and wherein generating, based at least partly on the belief map, the suppression command comprises determining a next mitigating task associated with minimization of damages and generating the suppression command including the next mitigating task.

4. The device of claim 3, wherein the guidance command is based at least partly on the second target location, a current position of the surveillance agent, and the first target location.

5. The device of claim 4, wherein the guidance command is based at least partly on an uncertainty map generated based at least partly on the belief map, and wherein the suppression command is based at least partly on a propagation model generated based at least partly on the belief map.

6. The device of claim 1, wherein the observation data comprises image data or information derived from the captured image data.

7. The device of claim 1, wherein the wildfire mitigation manager is implemented at a ground station, onboard the surveillance agent, and/or onboard the suppression agent.

8. A non-transitory computer-readable medium, storing a plurality of processor-executable instructions to:
receive, at a wildfire mitigation manager, from a surveillance agent, observation data and surveillance agent position data;
generate, based at least partly on the observation data and the surveillance agent position data, a belief map;
generate, based at least partly on the belief map and the surveillance agent position data, a guidance command;
send, to the surveillance agent, the guidance command;
generate, based at least partly on the belief map, a suppression command; and
send, to a suppression agent, the suppression command.

9. The non-transitory computer-readable medium of claim 8, wherein the surveillance agent is an unmanned aircraft and wherein the suppression agent is a manned aircraft.

10. The non-transitory computer-readable medium of claim 8, wherein the surveillance agent position data comprises altitude and global positioning system (GPS) data, wherein the guidance command comprises a first target location and wherein the suppression command comprises a second target location, and wherein generating, based at least partly on the belief map, the suppression command comprises determining a next mitigating task associated with minimization of damages and generating the suppression command including the next mitigating task.

11. The non-transitory computer-readable medium of claim 10, wherein the guidance command is based at least partly on the second target location, a current position of the surveillance agent, and the first target location.

12. The non-transitory computer-readable medium of claim 11, wherein the guidance command is based at least partly on an uncertainty map generated based at least partly on the belief map, and wherein the suppression command is based at least partly on a propagation model generated based at least partly on the belief map.

13. The non-transitory computer-readable medium of claim 8, wherein the observation data comprises image data or information derived from the captured image data.

14. The non-transitory computer-readable medium of claim 8, wherein the wildfire mitigation manager is implemented at a ground station, onboard the surveillance agent, and/or onboard the suppression agent.

15. A method comprising:
receiving, at a wildfire mitigation manager, from a surveillance agent, observation data and surveillance agent position data;
generating, based at least partly on the observation data and the surveillance agent position data, a belief map;
generating, based at least partly on the belief map and the surveillance agent position data, a guidance command;
sending, to the surveillance agent, the guidance command;
generating, based at least partly on the belief map, a suppression command; and
sending, to a suppression agent, the suppression command.

16. The method of claim 15, wherein the surveillance agent is an unmanned aircraft and wherein the suppression agent is a manned aircraft.

17. The method of claim 15, wherein the surveillance agent position data comprises altitude and global positioning system (GPS) data, wherein the guidance command comprises a first target location and wherein the suppression command comprises a second target location, and wherein generating, based at least partly on the belief map, the suppression command comprises determining a next mitigating task associated with minimization of damages and generating the suppression command including the next mitigating task.

18. The method of claim 17, wherein the guidance command is based at least partly on the second target location, a current position of the surveillance agent, and the first target location, and wherein the guidance command is based at least partly on an uncertainty map generated based at least partly on the belief map, and wherein the suppression command is based at least partly on a propagation model generated based at least partly on the belief map.

19. The method of claim 15, wherein the observation data comprises image data or information derived from the captured image data, and wherein the wildfire mitigation manager is implemented at a ground station, onboard the surveillance agent, and/or onboard the suppression agent.

20. The method of claim 15 further comprising:
generating, based at least partly on the belief map, a set of outer ring predictions;
comparing each of the outer ring predictions from the set of outer ring predictions to specified deployment criteria; and
dispatching another suppression agent when at least one outer ring prediction from the set of outer ring predictions meets the specified deployment criteria.
